(19) United States
(12) Patent Application Publication
(10) Pub. No.: US 2007/0112727 A1
(43) Pub. Date: May 17, 2007

(54) Method for querying collated data sets

(76) Inventors: Lewis Frier Jardine, Oxfordshire (GB); Anatoliy Olegovich Krasavin, Oxfordshire (GB); Andrew Wilmot Rawlin Payne, Oxfordshire (GB); Steven Porter, Oxfordshire (GB)

Correspondence Address: INTELLECTUAL PROPERTY / TECHNOLOGY LAW, PO BOX 14329, RESEARCH TRIANGLE PARK, NC, 27709, US

(21) Appl. No.: 10/563,473

(22) PCT Filed: Jun. 22, 2004
(86) PCT No.: PCT/EP04/06812

§ 371 Date: Jan. 4, 2006

(30) Foreign Application Priority Data
Jul. 4, 2003 (GB) 0315636.1

(51) Int. Cl. G06F 17/30

(52) U.S. Cl. 707/3

(57) ABSTRACT

A method and system for searching at least one data source using a query is described. In a first step one or more query templates are generated in which each query template can be used to define at least a part of the query. Several of the query templates are joined logically to create a query representation and input variables are selected or inputted into data entry fields. Subsequently, those data elements which will be returned by the query are selected and finally a query generated which is sent to at least one data source.

### BACKGROUND OF THE INVENTION

Within many fields of information management, data about a particular entity is spread across a variety of different databases and data sources.

As a generic example of data integration we now consider how a government agency might make use of the content of the databases they hold about each one of us. We use this example merely to highlight the power of data integration without delving into specific examples in Life Sciences.

Firstly lets us briefly review the sort of data available. Some may be held directly by the government agencies and other information may be held by commercial organisations with some access from government agencies

Government and local authority records:
Electoral Register
Income Tax
National Insurance Records
Companies House
Driving and vehicle licenses
TV licences
Immigration, passports and visas
Criminal records
Public services (Military service, Police, Civil service)
Patents
Birth, marriages and deaths
Medical records

Possible information available from other sources:
Credit references
Bank accounts
Mobile telephone and land line records
Car insurance
Web access and email

Now imagine that the totality of this information can be searched and browsed as if there were no departmental, computational or legislative barriers to such use.

In such an environment it would be relatively easy for a revenue investigator to find all those people who own a Porsche less than two years old, but have incomes of less than £10000 per annum and are registered at an address where the aggregate income of the household is less than £25000.

Once such people are found we can then start to browse and drill down into information about such people—for instance we might be interested to find out if they have a criminal record, the balance and movement of funds in their bank accounts or possibly even find out the names of associates . . . .

Within life science a similar number of diverse databases exist and it is a commercial priority to make optimal use of these information resources in the search for new medicines. Despite the huge investment in new experimental techniques, the number of drugs approved by the Food and Drugs Administration (FDA) has dropped from a peak of 53 in 1996 to only 24 in 2001. Whilst, according to Pharmaprojects the number of drugs in pre-clinical development has increased by 9% in the same period, R&D productivity is not responding to the radical changes in processes and technology that this industry has undergone. New research technologies such as combinatorial chemistry, high throughput screening, genomics, proteomics, pharmacogenomics and expression profiling have lead to vast increases in both the volumes of data and the number of different data types. Rather than finding the needle in the haystack pharmaceutical companies are simply adding more hay. The keys to success lie not only in new experimental techniques and the industrialization of research processes but in utilising existing data more effectively to make better decisions that are likely to yield profitable drugs rather than costly failures.

As an example, information about a particular protein may be held in protein sequence, crystallographic, high throughput screening and medical databases. The ability to search for a particular protein using all of the information available remains problematic for a number of reasons.

Prior Art

Tools now exist that can integrate the existing diverse data sources and computational engines within a unifying middleware layer. IBM's DiscoveryLink, MetaMatrix's MetaBase modeller and GeneticXchange's Discovery Hub all provide a means by which queries may be composed in SQL, or other query languages, and the query then run against all data sources that have been integrated at the middleware layer. Using such tools it is theoretically possible for a scientist to write a single query using SQL that uses information from chemical, genetic, pharmacological and medical databases.

However, the value of this middleware data integration is reduced since scientists lack the skills required to write queries in the available query languages (e.g., SQL) and also lack the detailed knowledge of the underlying database architectures and schemas. In fact the knowledge of the underlying databases tends to be broadly spread across the IT organisation supporting the scientists. It would be very hard for a single seasoned IT professional to write a cross-domain query for the scientist.

As these unifying middleware solutions have emerged, tools that integrate data at the presentation layer have also been developed. For instance, LION bioscience's DiscoveryCenter provides a way of collating data sets so that a scientist can view all the information available about a particular data entity in a single screen regardless of the source of that data. In addition such tools provide a mechanism for hyper-linking these collated data sets so that the scientist can navigate from a screen about one entity to screens showing data on related entities. For instance, a collated data set about a particular protein entity provides hyperlinks to a collated data set for a gene that codes for that protein, to an assay that is associated with the protein, or to a disease in which the protein plays a part in the aetiology. UK Patent Application No. GB-A-2 354 849 (IBM) offers one simplified method for generating an SQL expression for database query. In this application, a graphical user interface is disclosed which includes means for defining one or more tree structures comprising a hierarchical series of nodes and one or more lists. Each item of a list is associated with a node of a tree. An expression generator analyses the graphical definition created by the user and generates an SQL expression based on the structure of the tree and any list items associated with the tree.

Similarly UK Patent Application No. GB-A-2 343 530 (Oldfield et al, assigned to ICL) teaches a nested graphical representation of Boolean expressions to assist in the querying of databases. The computer system includes a graphical user interface which displays logic conditions with nested graphical containers (e.g. boxes) representing nested Boolean expressions. Various pop-up menus assist the user in adding or deleting the logic conditions. Containers and conditions may be dragged around to modify the logic.

Another approach to generating database queries is disclosed in US Patent Application Publication No. US 2002/0169759 (Kraft et al., assigned to IBM). The user interface in this publication also provides graphic means to formulate a search query. The user interface provides means for selecting a visual representation of a search object. The visual representation of the search object is dropped into a visual representation representing a domain object. On dropping the search object into the visual representation of the domain object, a search query is generated which can be sent to the database.

In European Patent Application No. EP-A-0 541 298 (Banning et al, assigned to IBM) a graphical database query system is disclosed. Display means are provided in which a plurality of parameters related to queries are displayed. Selection means are provided for selecting a set of the displayed parameters in order to define a require query. Operating means are responsive to the selection of the parameters and perform the required query and finally display means display the result of the required query.

None of these above publications describes the use of the graphical method for concurrently searching more than one database, such as those found in the biological and pharmaceutical fields. Furthermore there is no disclosure in these publications about collating data from more than one database in a format which can be readily understood and used by the user of the database system.

One prior art publication which does describe a computer system with an interface to more than one database is U.S. Pat. No. 6,236,328 (Coden et al, assigned to IBM. This teaches an object-oriented query model for querying multiple databases. The computer system has a plurality of base query objects defined, whereby each one of the base query objects is capable of querying a specific database. These can be combined together to query the databases.

US Patent Application Publication No. US-A-2002/0032675 also describes an information retrieval system for retrieving information from multiple information sources. The system works by building dynamic queries through the use of so-called query channels. A query channel permits the parsing of attributes of the search results between different queries.

Because of the growth in biological, medical and pharmaceutical knowledge the data in databases can rapidly change. Two prior art publications are known which describe system in which dynamic querying can be carried out. U.S. Pat. No. 5,421,008 teaches a method, system and program providing graphical queries. Tables and lists are configured from a database to define a common data structure. Dynamic data structures are employed based on the information entered by a user to define various relationships between the dynamic data and the database information. US-Patent Application Publication No. US-A-2002/0123984 (Prakash) a framework for the creation and execution of a dynamic query is taught. Graphical user interface screens will allow a user to create leaf conditions (or expression) and logically join the leaf conditions into more complex conditions. These conditions are then joined into a query. However, neither of these publications teaches a system in which the querying is carried out on medical databases, nor do they teach how links between data can be followed to create a better understanding of the data.

Databases for storing biological, medical and pharmaceutical data are also known in the art. For example, PCT Publication No. WO-A-02/054187 (Leveque et al, assigned to Scientia, Inc.) teaches a database for collecting and managing clinical information. The database includes the aggregation, anonymisation, analysis and dissemination of information including the susceptibility, progression, severity of disease, the resources utilised to treat the diseases, the quality of patient life, the ability to participate in the workforce and survival. The information provides an understanding about why genetically similar or identical patients express diseases differently.

Similarly, US Patent Application Publication No. US-A-2002/0052671 (Fey et al) teaches a genetic health data management system for collecting genetic screening and demographic data from clients. The system stores the clients' data and DNA/genetic material samples and processes and analyses genetic testing data in conjunction with other relevant health data. The system allows the generation of custom reports and maintains life-long health records.

One example of a system to allow the integration of multiple data sources in life science applications is described in US Patent Application Publication No. US-A-2002/0156756 (Stanley et al, assigned to Biosentients, Inc.). In this publication, methods are described to define and describe a specific embodiment of architecture for a so-called Intelligent Object data structure. The Intelligent Objects contain hierarchical, multi-layered property panes for unified user presentation and functional interactivity, as well as components and access interfaces to provide data status management, self-organising data and parallel data-to-data information interchange and processing.

All of the approaches described in the prior art define the query with respect to raw databases and tables. In contrast thereto, this invention describes a method for defining a query on the collated data sets, rather than the tables and fields of multiple databases.

### SUMMARY OF THE INVENTION

Although the prior art solutions offer some solutions to the problems of querying multiple data sources, there is a need to simplify the process to enable researchers without detailed knowledge of the individual database structures to perform meaningful ad-hoc searches.

There is furthermore a need to isolate searches from changes in the schemas of raw data sources.

There is furthermore a need to express a database query graphically.

These and other objects of the invention are solved by providing a method for searching at least one data source using a query and comprising the following steps: a first step of generating a plurality of query templates. Each of the query templates can be used to define at least a part of the query. A second step of logically joining at least some of said plurality of query templates to create a query representation. A third step of inputting or selecting input variables into data entry fields of the query representation. A fourth step for selecting data elements that will be returned by the query. A fifth step of generating the query using the query representation, input variables and the data elements to be returned. A sixth step of sending said query to the at least one data source. A seventh step of returning source results generated using the query from the at least one data source. An eighth step of generating a reference to a collated data set for each of the source results and a ninth step of selecting one of source results.

A collated data set in this application refers to a data set about a particular entity in which a number of related source results from one or more data sources are collected together. Users familiar with the content and hyperlinked structure of collated data sets will naturally wish to perform searches which return collated data sets that conform to a set of criteria. For such user, it is therefore entirely logical to allow them to define a search in the context of the collated data sets. Once the users have defined, in this way, the system performs a search that returns references to matching collated data sets. Although this method allows a user to define a query in the context of collated data sets, such collated data sets to not need to be created on the fly or stored in the system in any manner during the searching process. This drastically reduces the memory requirements, the searching time and ensures that search results accurately reflect the content of the raw databases.

The collated data sets will be generally referred to as dossiers, but the choice of this term is not to be limiting. The method of the invention also includes a prior step of defining how to generate one or more types of collated data set. Each collated data set comprising of one or more reports.

The query templates used in the method are related to the report definitions. So the system implementing the method can use all or part of the report definitions in order to construct the query. Similarly, the query representation is defined with reference to the reports. Generation of the query template can be done automatically from the report definition once the report definition has been created by the administrator or user of the system. This ensures that the results displayed in the report are accurate.

In one embodiment of the invention, a search is carried out for matching dossiers using the query representation. This can be done, for example, by directly searching the data sources from which the dossiers are derived. Alternatively or additionally, this is carried out by comparing other ones of the dossiers that are indirectly or directly referenced by the dossier being matched.

Advantageously, the method further comprises a step of hyperlinking from an element of the displayed dossier to another dossier. This allows the user 10 to easily navigate from one element of the dossier to another relevant dossier.

The dossier definition includes one or more instances of a report definition. Each report definition includes a retrieval definition to define how the members may be retrieved from a data source, a display definition defining how the results may be displayed, and an access definition for defining the permitted access to an instance of the report definition. Furthermore, the dossier definition can additionally include one or more dossier reference definitions in which the dossier reference definition defines a link between at least one instance of the report definition and at least one instance of a dossier definition. So, for example, the dossier reference definition can define how a hyperlink is created between an element of a report and the same or another dossier.

In an advantageous embodiment of the invention, the method further includes a step of taking the retrieval definition and inverting said retrieval definition to create a search definition. This search definition can be used in the construction of a query that will retrieve source results. Similarly the method also includes a step of taking the display definition and inverting said display definition to create a template form.

A further embodiment of the invention includes a step of creating a dossier linkage relationship between an element in a template form with a corresponding one of the dossier definitions. This dossier linkage relationship is created using the dossier reference definition in a corresponding one of the report definitions.

The step of creating a query representation comprises in the invention a step of assembling a query structure in which said plurality of query templates are joined using nesting and/or Boolean logic. The query representation layer is then constructed by using a plurality of query templates logically joined together using Boolean logic. The query representation can also be constructed with a plurality of nested query representation layers. The nested query representation layers may be used to check the content of dossiers directly or indirectly referenced by the matching dossier.

In yet a further embodiment of the invention, the method further comprises a step of creating a plurality of query context subsets of the plurality of query templates. Each query context subset contains query templates that are associated with a single dossier definition through report template mapping. Each query representation layer may only contain query templates from a single query context subset.

Access restrictions in the method can be controlled by creating a plurality of access control subsets of the plurality of query templates. Each access control subset contains only those query templates that may be accessed by a particular user of the system. Retrieval of query representations are blocked for those query representations which contain query templates not belonging to the access control subset for the user.

A further embodiment of the method includes a step of creating a dossier linkage subset having one or more dossier definitions. Each member of the dossier linkage subset has a dossier linkage relationship with the said selected one of the plurality of query templates. The so-called context of the query representation layer is established by selecting a member of said dossier linkage subset.

The method also includes a step of nesting a retrieved query representation below a selected one of the plurality of query templates in the current query representation. The initial context of the retrieved query representation has a dossier linkage relationship with the said selected one of the plurality of query templates under which it will be nested.

In a further embodiment of the invention, a template linkage subset is created of the plurality of query templates that have a linkage relationship to the query context of the said query representation layer.

The method of the invention further comprises a step of assembling one or more compound query templates from the plurality of query templates and using the compound query templates to create a query representation.

The invention also includes a system for searching data with a display device for displaying and editing a set of query templates with data entry fields, an input device for inputting at least one variable into at least one of the set of query templates, a query generation device to generate a query using the method of the invention, and a display device for viewing the query that will be sent to one or more databases.

This patent describes a method for searching such hyperlinked collated data sets. A method that embodies the notion of providing a unifying middleware layer but also provides a means of expressing a query within the context of collated data sets (or “dossiers”). The administrators of the system, such as IT professionals, will be responsible for defining the types of dossiers that may be available and the content of the data sets (or “reports”) within each dossier type. For instance, within life sciences dossier types might include: protein, gene, screen, disease, chromosome, chemical, batch, scientist, protocol etc. The reports within a protein dossier might include: amino acid sequence, allotypic variants, homologous proteins, 3D crystal structures and related genes etc. The display of the list of related genes would contain hyperlinks to dossiers on each gene. Using this method, for instance, a scientist may define a search for a particular protein based both on the properties of the protein and properties of related genes. Such a search is defined in terms of the contents of the dossiers and reports.

Within this patent we describe a method by which a graphical query is represented in terms of features or properties of collated data sets and features or properties of collated data sets that hyperlink to or from data sets referenced directly or indirectly by the data set under the scrutiny of matching algorithm. This method takes such a query representation and generates a database query that may be performed against the raw data sources or those data sources unified in a middleware layer. And, once the results are returned, converts these into references to a set of collated data sets that meet the constraints of the query representation. The method therefore does not generate and search all collated data sets, this would be computationally grossly inefficient. As such this patent describes a method for graphically querying virtual collated data sets.

Whilst the description above uses examples from Life Science research—similar problems occur in many other industries. Our method provides both a powerful way of expressing a query graphically and also provides a layer of abstraction from the raw databases. A user of the system and method, such as a researcher or a knowledge-worker, will be able to perform complex and highly flexible queries with neither the knowledge of traditional query languages nor knowledge of the underlying database architectures and schemas.

### DESCRIPTION OF THE DRAWINGS

FIG. 1 shows a searching system

FIG. 2 shows a diagrammatic representation of a set of dossiers

FIG. 3 shows a report and its associated template

FIG. 4 shows another report and its associated template

FIG. 5 shows a further report and its associated template

FIG. 6 shows an assay report

FIG. 7 shows an assay template

FIG. 8 shows the relationship between dossiers and query representations using reverse linking

FIG. 9 shows a dossier definition in XML

FIG. 10 shows the relationship between report definitions and templates

FIG. 11 shows the relationship between dossier definitions, URNs and dossiers

FIG. 12 shows the relationship between dossiers and query representations using forward linking

### DETAILED DESCRIPTION OF THE INVENTION

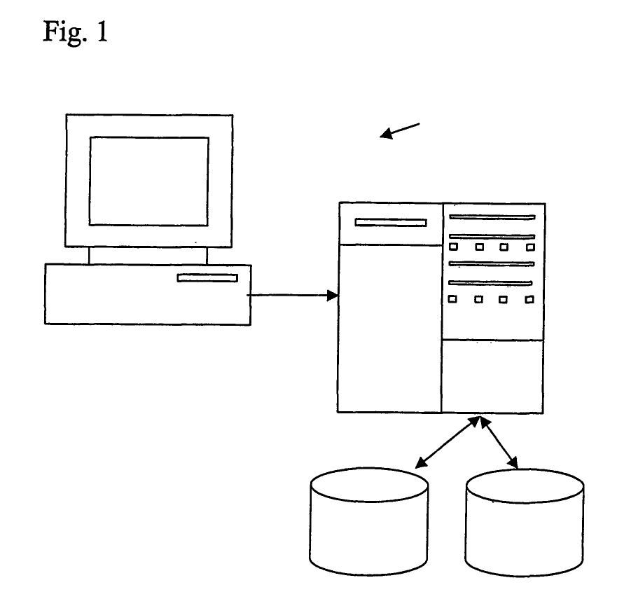

FIG. 1 shows a diagram of a user 10 of a searching system 20. The user 10 could be a scientist, an information specialist, a knowledge-worker, a medical doctor or any interested person. The searching system 20 comprises a workstation 30 connected through a network 40 with a server 50. The server 50 is running a search engine 60 which can access a plurality of databases 70 and/or other data sources 80.

The invention described in this patent application provides a framework for the creation of electronic dossiers by the user 10 within the searching system 20. In the context of this invention, a dossier contains a plurality of reports on everything known about a particular entity, e.g. a gene, an experiment, a researcher, a chemical substance. A report can contain the results of a query on a database(s) 70 and/or other data sources 80, such as an internal web page, and external web page, a document or list of documents, the results of a computation etc. For instance a molecule dossier on a specific chemical might contain a 2D representation of the molecule, a 3D representation, a list of all the batches of the molecule that have been made, a list of all the biological assays that have been performed on the molecule, results of quantum mechanics calculations, list of safety instructions, the full IUPAC chemical name, patent information on the compound. From the point of view of the user 10 putting all the information about a particular entity in one place (i.e. in the dossier), has enormous benefits and saves much time spent collating the information needed to make decisions.

Entries in the reports may contain hyperlinks to other dossiers. For instance one of the reports within the molecule dossier would contain a report about the batches that have been synthesised. We can create a hyperlink from the names of the batches to separate batch dossiers on each batch. The batch dossier would contain reports on samples of each batch, the amount, location, form etc. The batch dossier might also contain a report on the impurities in each batch or the spectra used for the structural determination.

The molecule dossier might also contain hyperlinks to an assay dossier. The assay dossiers in turn contain hyperlinks to protein dossiers and the protein dossiers contain links to gene dossiers etc. In this way it is possible to build a network of hyperlinked dossiers that provide the user 10 with a very powerful way to search and browse data.

The IT (Information Technology) groups within pharmaceutical and biotech companies are responsible for defining the types of the dossiers available to the users 10 and also the reports that the dossiers contain. For instance, assume that protein dossiers have been created with reports relating to proteins. An administrator from the IT groups can now add report definitions to this dossier type. Each report definition will take an identification number for the protein of interest and generate specific reports for the protein of interest. Other groups and companies can also create dossiers and reports. These will be collectively termed dossier creators.

The workstation 30 is running an internet browser program such as Microsoft Internet Explorer or Netscape Navigator. The dossiers are directly addressable in the same sense that a web page is directly addressable through a URL (Uniform Resource Locator). Specific dossiers are assigned and addressed through a URN (Universal Resource Name) and this makes it possible to send a reference to a dossier in an email.

The form of the URN follows a standard industry notation:
URN:x-contentType:repository[.release]:id[.version]

For instance a URN for a specific protein sequence held in SWISSPROT would look like:
URN:x-protein:SWISSPROT:P3845

On entry of the URN by the user 10 in the searching system 20, the searching system 20 has first to resolve which one of the dossier types needs to be created from the different dossier types available. This is done on the basis of the content type, the data source 70 or 80, the release, the entity id, the version number, the security, the user 10 and the user's 10 preferences.

Once the dossier type has been selected, the searching system 20 selects and then uses a specific dossier definition to create a selected dossier. The dossier definition includes a description of the reports that make up the dossier. The dossier definition includes both references to child dossiers and reports. These dossiers and reports form the model part of a model view controller (MVC) architecture.

A view of the selected dossier is constructed from the model and comprises two parts. The first part of the view is used for navigation through the dossier and the selection of specific reports. The second part of the view is the display of one or more of those reports. One specific example of a view is dynamically generated web pages displayed in a browser containing a navigational tree and reports in separate panels. Other views and viewing mechanisms could also be created within this architecture. One example might be for instance a thick client application.

Dossier types are heavily customisable to fit their context. A new dossier type (i.e. a child dossier type) may be created based upon on existing dossier type with one or two changes. This ‘inheritance mechanism’ allows the factoring out of the common aspects of the different dossier types. Furthermore dossiers types may contain other dossiers types in order to group reports definitions.

Reports used in the dossier can be of several types. Standard reports are read-only constructs that merely present information and do not provide the user 10 with any mechanism by which the user 10 can modify data. Actions are a special type of report that allow active interaction between the user 10 and the data. For instance, whilst viewing a molecule dossier, the user 10 might want to request that the molecule was sent for further testing. Other actions might include simple sorting and filtering within a spreadsheet, parameterisation and activation of a computational engine, annotation or data entry into database or data export to a client side program such as Excel.

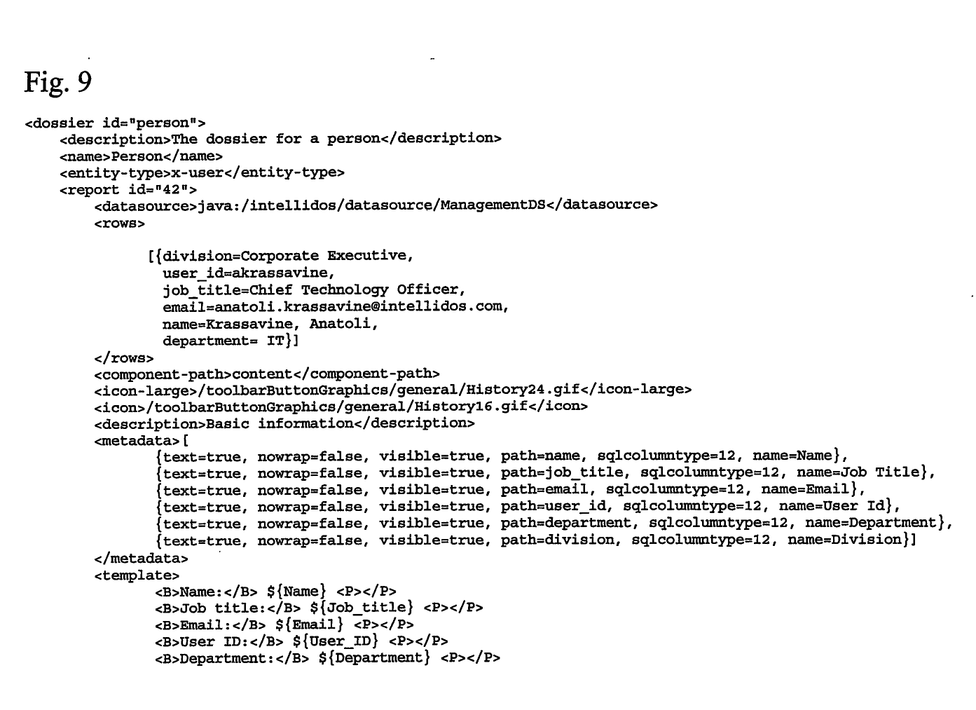

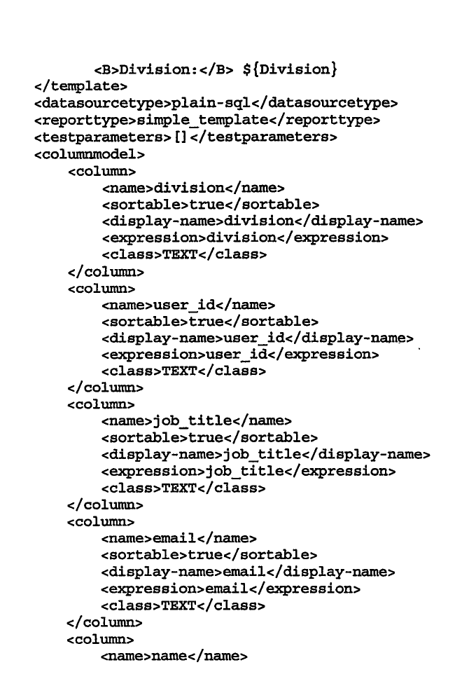

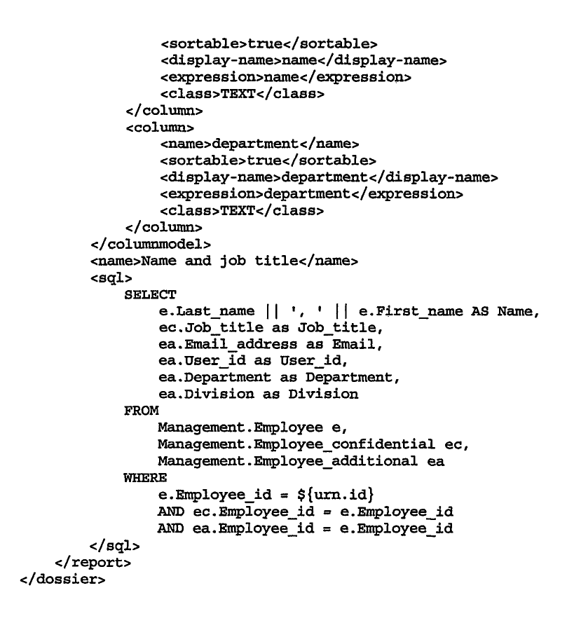

Dossier definitions can be programmed using a variety of programming languages and standards. In the preferred embodiment of the invention, the dossier definition is in the form of an XML document. An example of such a dossier definition is given in FIG. 9 which shows a dossier definition for a person containing a single report which shows the name, job title, email, user id and department for a given individual. This example is only one example of a dossier definition and more complex definitions may be created using the features of the XML programming language.

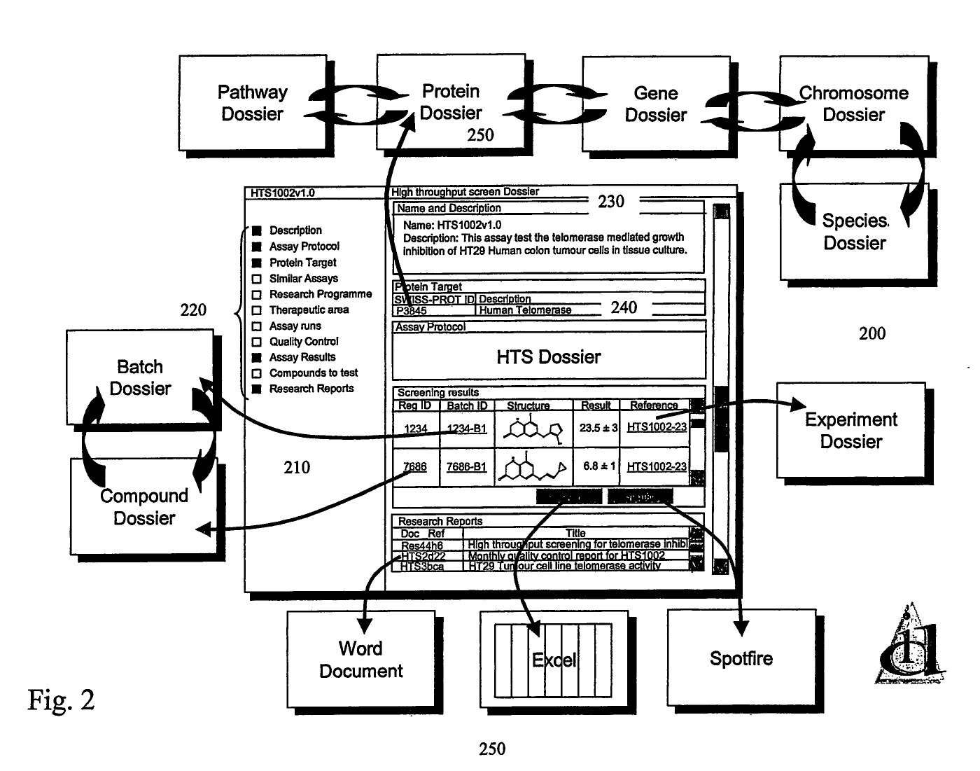

FIG. 2 shows a diagrammatic representation of a set of dossiers. In the central part of the diagram there is a conceptual drawing of a dossier 200 on a particular kind of biological assay, i.e. an assay dossier. The biological assays are often similar to pregnancy test kits in that we are trying to detect some kind of colour change in the wells of plastic plates after the introduction of a novel molecule. Pharmaceutical companies may test tens of thousand of compounds in such assays every day.

In the example shown the assay relates to how novel molecules inhibit the action of an enzyme that is responsible for the continuous division of tumour cells. We could similarly have chosen an assay related to irritable bowel syndrome, obesity or asthma. In all of these cases the structure of the assay dossier 200 would be very similar although obviously the content of the reports would vary.

The assay dossier 200 that appears on the screen at the workstation 30 has two panels. The left hand panel 210 shows a list of the reports 220 that are available in the assay dossier 200. These include a description of the screen, a protocol describing how the assay is performed, a list of similar assays, a list of all the results for molecules test in the assay, details on the protein with which the molecules interact etc. The right hand panel 230 displays all the reports that have been selected.

Let us first examine the report 240 labelled ‘Protein Target’. This report 240 is generated by searching a database 70 that links the names of assays to specific proteins into which the putative drugs will bind. The report 240 is generated using code, such as SQL code, which is generated by the administrator when setting up the assay dossier and its attendant reports. The report 240 has two columns and a single row, the right hand column gives a description of the protein ‘Human Telomerase’ and left hand column gives an ID labelled ‘P3845’. The ID labelled ‘P3845’ is a link into the existing protein sequence database called SWISSPROT and in particular to the protein with ID ‘P3845’. On display on the workstation 30, the ID will be shown in blue and underlined indicating that this is a hyperlink to another one 250 of the dossiers. For given a SWISSPROT ID it is possible to generate a complete dossier—a protein dossier 250—of information on the particular protein identified by the ID ‘P3845’ . . . .

This protein dossier 250 will contain for instance reports on the amino acid sequence for the protein, possibly a crystal structure, genetic variability of the protein, a link to the gene that codes for the protein, a list of diseases that have some association with the protein, a list of in house assays associated with the protein, structural domains of the protein, metabolic or signalling pathways in which the protein is involved.

We can therefore see that it becomes possible by virtue of the links to create a web of dossiers for many different types of entities found within life Science research.

The table below shows the ways in which links and their meaning can be established between life science dossiers:

TABLE 1
Ways of linking Life Science dossiers

| From | To | Relationship |
|---|---|---|
| Protein | Gene | A protein is coded by a specified gene |
| Gene | Protein | A gene can code for a number of different |
| | | proteins |
| Gene | Gene | Gene can link to other genes by virtue of |
| | | sequence homology |
| Protein | Protein | Proteins can link to other proteins by |
| | | virtue of sequence homology |
| Protein | Assay | A protein may have an associated assay(s) |
| | | in which the binding of drugs is measured |
| Assay | Protein | An assay may have an protein target |
| Protein | Pathway | A protein can be part of a metabolic or |
| | | signal transduction pathway |
| Pathway | Protein | A pathway may contain many different |
| | | proteins |
| Assay | Batch | A batch of small molecule is tested in an |
| | | assay |
| Batch | Assay | A batch of compound may be tested in |
| | | multiple assays |
| Batch | Molecule | A batch contains a primary constituent |
| | | and multiple impurities. |
| Molecule | Batch | A molecule can by synthesised multiple |
| | | times in different batches |
| Batch | Gene | A batch of compound can have an effect on |
| | | the expression of a particular gene. |
| Molecule | Person | A molecule can be made by a particular |
| | | chemist |
| Molecule | Protein | A protein can be docked in-silico into a |
| | | protein |
| Experiment | Person | An assay can be performed by a person |
| Research | Person | A research programme can be run by a |
| Programme | | particular person |
| Person | Task | A person can be assigned a series of tasks |

Access to the dossiers and/or reports within the dossiers can be restricted to certain users 10. The security mechanisms are based on and use existing security frameworks such as Java Authentication and Authorisation Service (JAAS) and Light Weight Directory Access Protocol (LDAP).

Based on usemame and password or other authentication mechanism, security may restrict access to the following entities:
The searching system 20
Administrative Tools
Specific Dossier Definitions
Specific Report Definitions
Specific Content Types
Specific Repositories
Specific Ids
Specific Action Definitions

The searching system 20 supports all standard features such as groups and roles.

Administration dossiers can be provided to administer the system. For instance dossiers on users 10 are provided and the reports and actions they contain can be used administer monitor and configure the searching system 20.

The definitions of dossiers can be created and edited using wizards or can be transferred in XML format.

Activity of the user 10 is logged and can be viewed by suitably authorised users 10 or administrators. For instance, when a particular user 10 logs on or logs off of the searching system 20, when dossier or a report is viewed at the workstation 30 and when actions are performed. Such a logging system would allow pay per view billing systems to be built using dossiers and reports.

Any URN can be specified as a favourite for a particular user 10 and the user can add a comment and/or use this as a bookmark in the internet browser for rapid re-access of the specific dossier. This facility is incorporated into the latest version of the internet browsers.

The user 10 can define the visibility and accessibility of their list of favourites in the internet browser. If they make one of the favourites public, all other members of their organisation can see that they have an interest in that particular entity. Such mechanisms promote collaboration over geographical and departmental boundaries.

When ever something significant happens in the searching system 20, event messages can be fired. Alert controllers examine the stream of event messages to determine whether or not to take action based on them. This is done by comparing previously stored event messages with new messages. One manner in which this is done is to prepare and store a hash value of the old message and compare the stored hash value with a newly calculated hash value. Examples of action might be notifying a list of interested users 10 that a particular database 70 has been updated, notifying a user 10 that another user has made a favourite of one of the items in the first user's list of favourites, or one of a user's 10 favourites has been annotated or updated.

Alerts may also be used by administrators to monitor the searching system 20, For instance, notifying the administrator when a user 10 logs in from more than one machine at the same time, or when a password has been entered incorrectly three times in a row, when a data source 70 has gone down or when a dossier definition was modified etc.

The alert controllers decide to whom an alert message should be sent and the content of the message. Each controller may use one or more methods for sending the message to the user e.g. by email, SMS message or flags in reports.

The searching system 20 can include a plurality of server computers 50 which can work together. Specific ones of the dossiers and reports can be shared between individual ones of the server computers 50. This allows reports to be shared between companies with sharing the data sources 70 and 80 from which they are generated. Each company or user 10 is in control of their own security rules.

The searching system 20 includes a query constructor tool for searching for the dossier that meets a set of criteria This can be better understood by considering the tools as expression queries within the context of the dossier and reports, rather than the queries being carried out on databases and tables within the databases. This enables an abstraction from the language of IT into the language of science, as well as saving memory space as discussed above. This means that the user 10 of the searching system 20 does not have to learn a new language or understand the architecture of the corporate databases. There is good anecdotal evidence to suggest that not one single person in the IT department of a big pharmaceutical company understand all of these either.

To understand how this abstraction is achieved within the product it is necessary to understand that queries are built from interconnected logic elements and template objects. A template object can be described as a small data entry form into which a user can enter text, numeric data including ranges or more complex items such as a chemical substructure query. A template also has an associated piece of SQL code which when combined with the data entered into the form part becomes part of the clause in the WHERE part of SQL query that is generated by the query constructor tool.

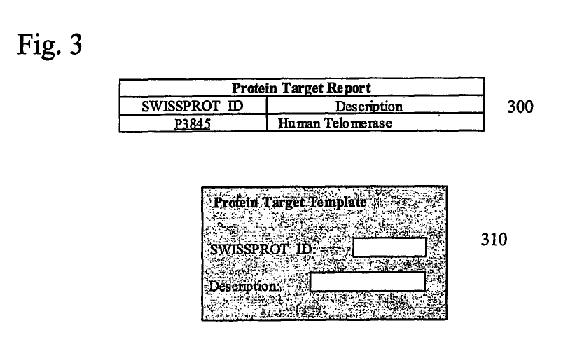

Template objects are associated with report definitions. Where possible all reports in the search system 20 will have associated templates in the query constructor tool. This mapping also defines that every template is associated with a particular dossier item. FIG. 3 shows this graphically. The upper part of FIG. 3 illustrates a protein target report 300 such as that displayed in FIG. 2. The lower part of FIG. 3 illustrates a protein target template 310 that can be used to specify queries that return entities of type assay (it will be recalled that the protein target report appears in the assay dossier).

Interestingly one of the effects of this mapping is that as an administrator adds more and more reports to a particular dossier the templates available in the query constructor tool also expands. The work performed by the administrator yields a double benefit.

The operation of the query constructor tool will now be illustrated. Imagine for a moment that query constructor tool could only manage a single template at a time (in fact the real power of the tool is far more extensive as we shall see).

The user 10 enters the variable “% guinea % in the description field of the protein target template 310 and runs the query. The query constructor tool takes the value of this variable and inputs into the SQL code already provided and stored in memory. The query constructor returns a list of URNs for all the protein dossiers in which the description field of the protein target report contains the word “guinea”. The user 10 can now drill down to view the dossiers of all the proteins returned by the query. From each of these dossiers the user 10 can utilise hyperlinks to view dossiers of other types associated with these proteins as explained with reference to FIG. 2.

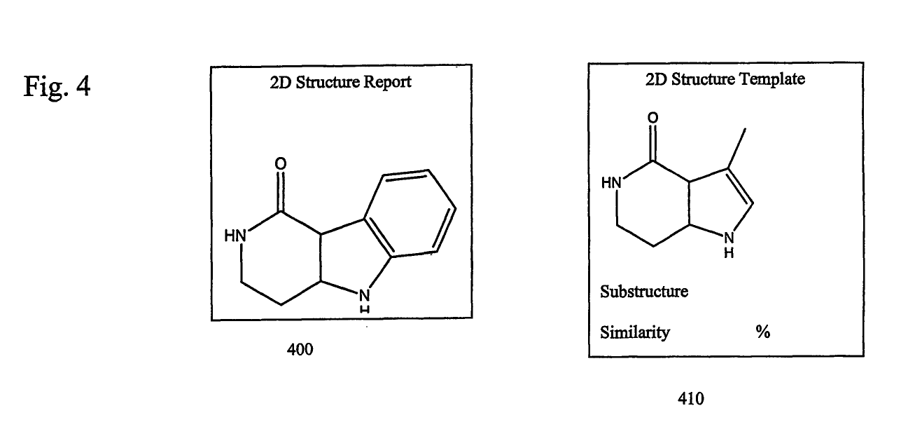

FIG. 4 shows another type of report and its corresponding template in the query constructor. In this figure, a structure report 400 within a small molecule dossier has a 2D representation of the molecular structure of the small molecule. The molecular structure may be furnished by an embedded Java chemical renderer in the searching system 20. Alternatively this could be generated in an image graphic file or using a plug-in for a browser. The template 410 in the query constructor tool has a corresponding chemical sketcher that allows users 10 to draw a structure and find similar molecules on the basis of substructure searching or chemical similarity in the data sources 70 and 80.

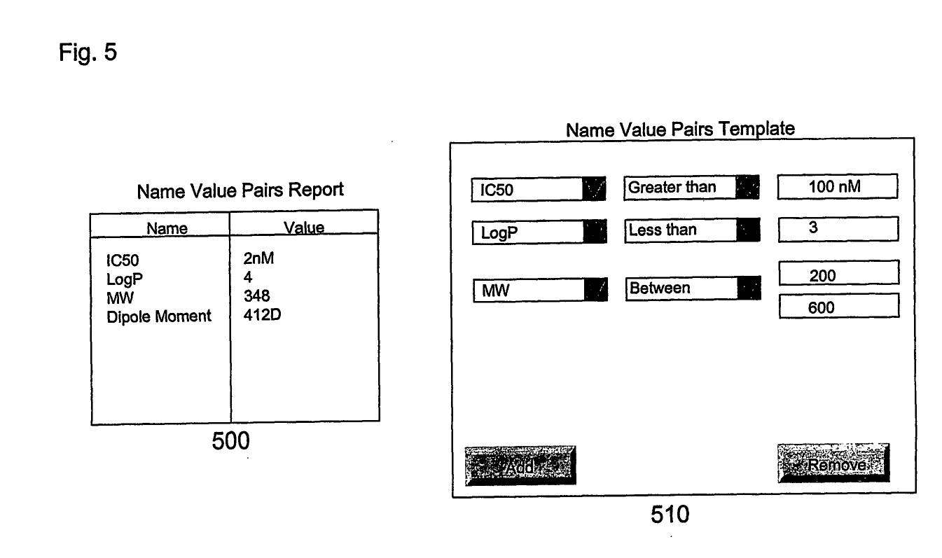

A further report and its corresponding template are shown in FIG. 5. FIG. 5 shows a name value report 500 that returns a list of name value pairs. The number of pairs is unknown until the time the name value report 500 is run. Such name value reports 510 are typically used for calculated physical properties in lead optimisation and refinement structure activity analysis. The name value template 510 allows any number of name-value pairs to be used to define which dossiers are returned.

As mentioned above, when the name value pair report 500 was created, the administrator would have had to write a piece of SQL code to generate the contents for the report. The query constructor tool can take this SQL code for the report and create “inverted” SQL for the template. This inverted SQL returns a set of URNs (identifiers of dossier) containing all those dossiers which match the query definition. The table below shows the SQL for the name value report 500 and the inverted SQL created automatically by query constructor toll for the name value template 510.

| Report | Template |
|---|---|
| SELECT B.name as Name, | SELECT C.URI as URI |

| | |
|---|---|
| A.IC50 as IC50 | FROM A, B, C |

| | |
|---|---|
| FROM A, B, C | WHERE (A.IC50 > 3 AND |

| | |
|---|---|
| WHERE C.URI = {URI} | A.LogP > 2 AND |

| | |
|---|---|
| AND A.Key = C.Key | A.MW < 500) AND |
| AND B.Key = C.Key | (A.Key = C.Key AND |

B.Key = C.Key)

It can be seen that more than one template can be used to specify a set of entities provided that all the templates are associated with the same type of dossier. Templates can be connected together using logic elements such as AND, OR, NOT etc.

At this stage of our discussion the set of entities to be returned can only be defined from the templates directly associated with the dossier for that type of entity. Although powerful we are not using all the information about the entities and their relationships that is embodied in the hyperlinks between them and as such limiting the flexibility of the query constructor tool.

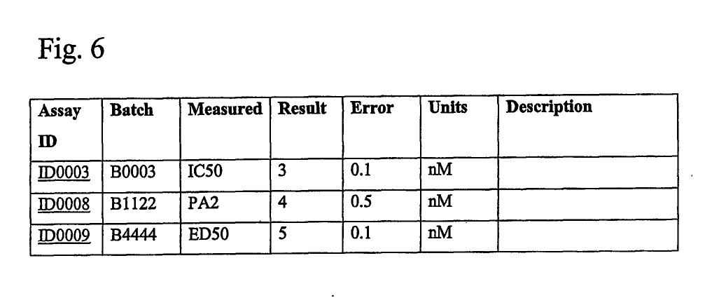

Lets us now define a report that contains links to other dossiers. This report is shown in FIG. 6 and belongs to a small molecule dossier and gives a list of all the assays in which this molecule has been tested (i.e. an assay report). Note that there are hyperlinks in the Assay ID column; these allow the user 10 using this assay report to drill down into the details of specific assays.

The SQL code used to generate the assay report shown in FIG. 6 is as follows:

SQL to generate the report

| SELECT | | | |
|---|---|---|---|
| | AOB.assay_id | AS ASSAY, | |
| | AOB.batch_regno | AS BATCH, | |
| | A.measurement | AS MEASURED, | |
| | AOB.assay_value | AS RESULT, | |
| | AOB.range | AS ERROR, | |
| | A.units | AS UNITS, | |
| | A.description | AS DESCRIPTION, | |
| | ‘urn:x-assay:ArrayDB:’ \|\| AOB.assay_id AS URI | | |
| FROM | | | |
| | ASSAYS_ON_BATCHES | | AOB, |
| | BATCHES | | B, |
| | ASSAYS | | A |

| WHERE | |
|---|---|
| | (AOB.batch_regno = B.batch_regno) |
| | AND (B.main_component = {URN}) |
| | AND (AOB.assay_id = A.assay_id) |

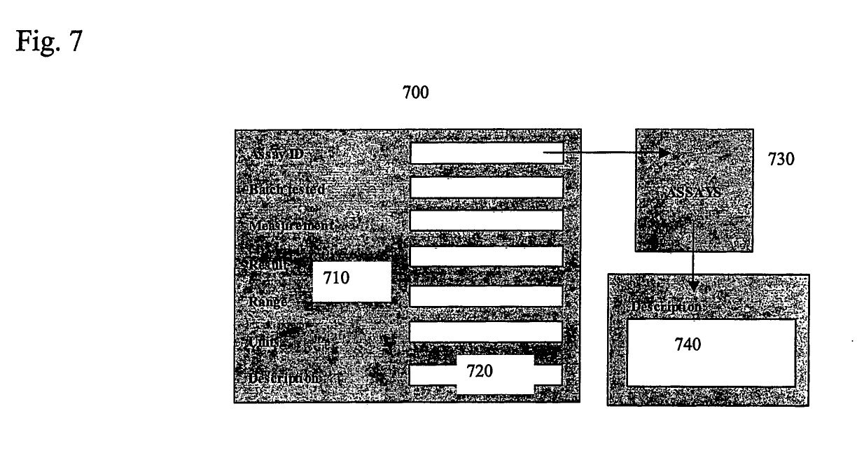

Lets us now examine what the assay template associated with this assay report would look like. This is shown in FIG. 7. In many respects it appears to be the same as that shown in FIG. 3. On the left of FIG. 7 we can see the familiar template 700 where each column has been mapped to a label 710 and an editable field 720. Where the entry in the editable field 720 can be used to select only those dossiers in which associated report contains matching ones of the entry. We can use the template to select batches of small molecule on the basis of their test results in various assays. To select the assays we can either use the editable field labelled “assay id” to specify a particular assay or use the templates from the assay dossiers to specify a particular subset of the assays in which the batch was tested.

On the right of the figure we show a template 730 for the assay description, from the assay dossier definition, connected to the assay id field of the template 710. The square labelled “ASSAYS” 730 indicates that the context of the query has changed from returning batches to returning assays.

The SQL code for generating this query is given below:

SQL to generate a query with linked templates

SELECT

| | |
|---|---|
| ‘urn:x-batch:BatchDB:’ \|\| | AOB.Batch_id AS URI |

FROM

| | |
|---|---|
| ASSAYS_ON_BATCHES | AOB, |
| BATCHES | B, |
| ASSAYS | A |

WHERE

(AOB.batch_regno = B.batch_regno) AND
(AOB.assay_id = A.assay_id) AND
(AOB.assay_value < 40) AND
(AOB.assay_id in

```
(
  select A.assay_id
  from ASSAY_TABLE A
  where
  (A.description LIKE ‘Guinea%’)
)
```

)

This SQL code for the template contains nested queries—the outer query represents the inverted query for the report from the small molecule dossier—and the nested part comes from a report associated with the assay dossier.

In summary, we can state that the generation of SQL code for the query with the query constructor tool can be generated with the following three rules.
For each template perform an inversion of the SQL used to create the report such that the inverted SQL returns the set of entities that will contain matching entries in the reports of every element of the set.
Where we combine multiple templates with simple logic elements use the same logic elements to connect the inverted SQL together.
Where we combine templates that are related through hyperlinks in reports place the nested inverted SQL for the linked to object within the inverted SQL of the linked from object.

Now we will look at a typical cross domain query and see how the query is represented graphically.

The query we use is an example taken from the IBM DiscoveryLink web site.

“Show me all the compounds that have been tested against members of the serotonin family of receptors, have IC50 values in the nanomolar/ml range, a molecular weight between 375 and 425, and a logP between 4 and 5.”

To build a query representation for the above query the invention allows the user 10 to employ two different methods to connect templates from different query context subsets.

Firstly we describe a forward reference method, in which we use the hyperlinks from a dossier that is being matched to referenced dossiers. And, secondly we also describe an embodiment of the invention in which we use the hyperlinks from related dossiers to the dossier being matched.

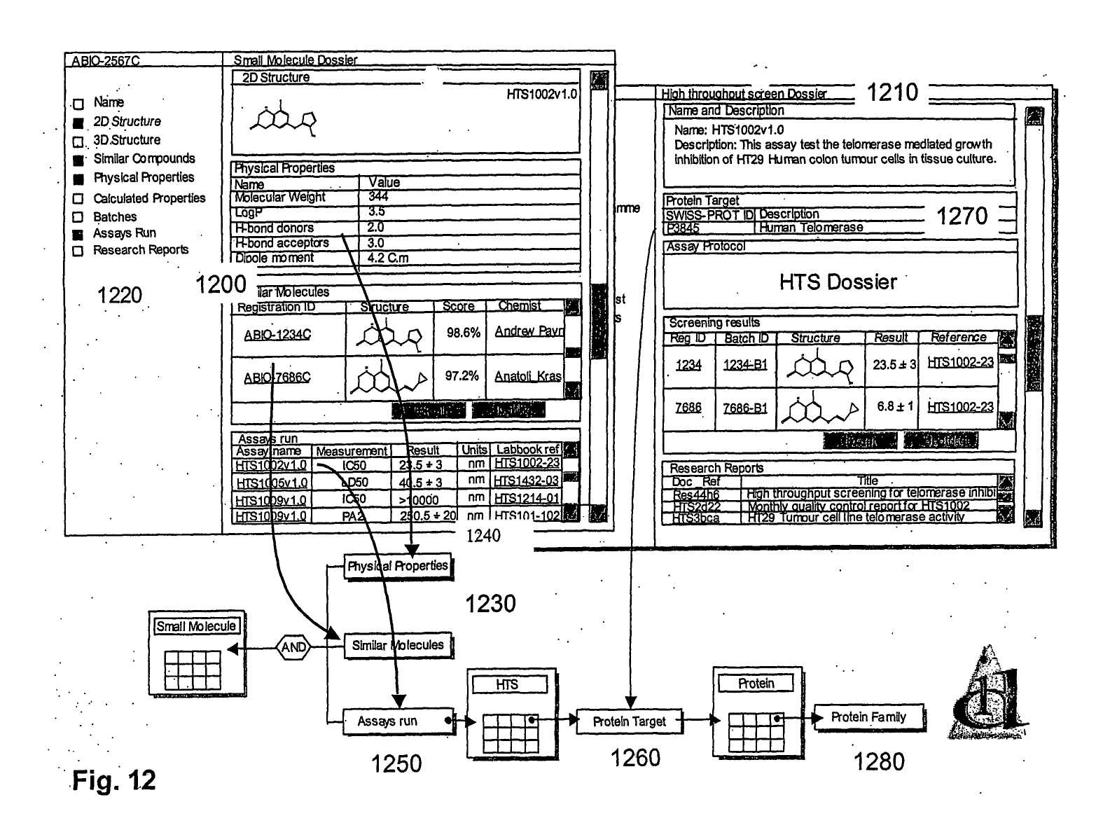

In FIG. 12 we can see the mapping of reports 1220 in the small molecule dossier 1200 to a set of templates 1230. These templates 1230 may be employed by the user 10 to select a set of references to small molecule dossiers. Note that the “assays run” report 1240 contains cells with hyperlinks to high throughput screening dossiers. Therefore the assay run template 1250 can reference additional templates from the high throughput screen dossier definition such as the protein target template 1260.

The protein target report 1270 in the high throughput screen dossier 1210 contains hyperlinks to a protein dossier and therefore we may use templates, such as the protein family template 1280, from the protein dossier definition to additionally constrain the selection of high throughput screens relevant to the search.

Frequently, hyperlinks between dossiers are bi-directional and therefore another embodiment of this invention includes the use of reverse hyperlinks. Thus in the above example we would use links from a protein to a screen and from a screen to a small molecule.

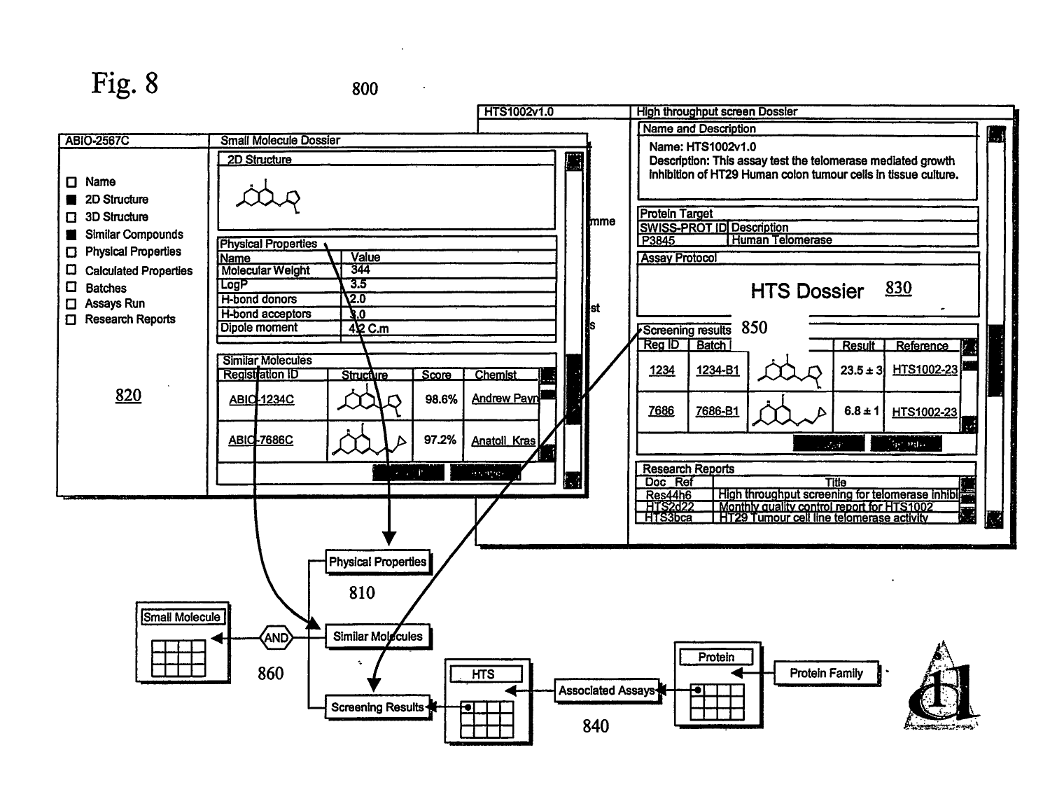

In FIG. 8, we can see the mapping from reports 800 to templates 810. Also, that a query for a set of small molecules is defined by two templates associated with the small molecule dossier combined with an AND logic element 860.

In the description above we used the hyperlink from a report in the small molecule dossier 820 to link to the assay dossier 830. It will be realised that we will frequently have bidirectional links and that there are potentially hyperlinks from reports in the assay dossier 830 to small molecule dossiers 820.

In FIG. 8 we have taken a template 840 that appears to be associated with a report 850 in the high throughput screen dossier 830 and used it to constrain the set of molecules returned. Note that the report 850 in the high throughput screen dossier 830 returns hyperlinks to small molecules and this is why it is logical for such so-called foreign templates to be permitted.

The screening results template 840 in FIG. 8 means “for a given set of high throughput screens 830 return all the molecules that have been screened in these screens and meet the other criteria of the template”. These molecules are then additionally filtered by the other templates 810 combined by the AND logic element 860.

The given set of high throughput screens is defined in exactly the same way as any other entity. Therefore such foreign templates have the effect of changing the context of the search.

In FIG. 8, the set of high throughput screens is constrained by a set of proteins associated with the screens and in turn the set of proteins is constrained by a template that defines a protein family.

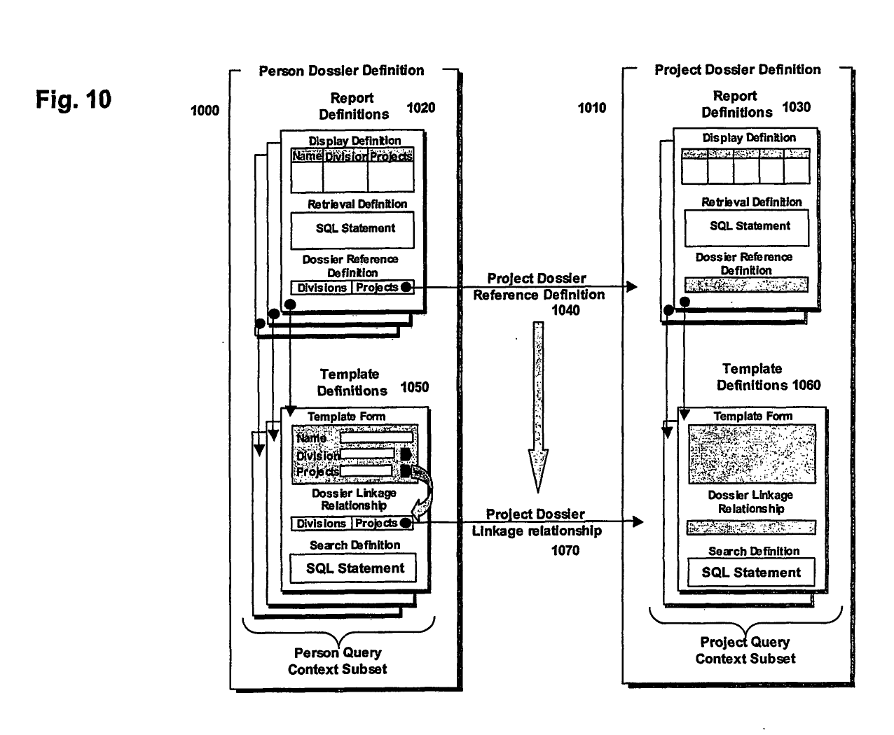

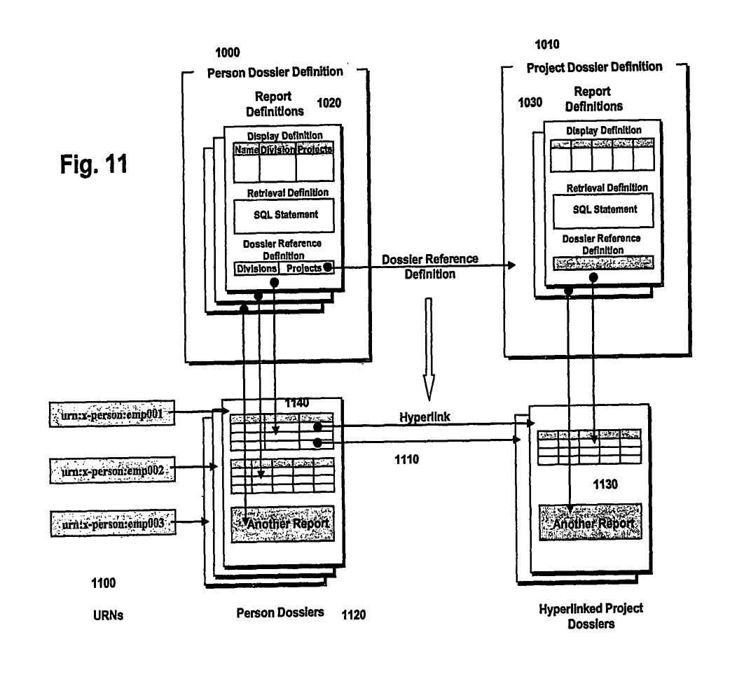

A further example of dossiers is shown in FIGS. 10 and 11 that includes person dossiers and project dossiers. In FIG. 10, the person dossier definition 1000 includes one or more instances (in this example three) of person report definitions 1020. Similarly a project dossier definition 1010 includes one or more instances of project report definitions 1030. Both the person report definitions 1020 and the project report definitions 1030 include a display definition for each report which instructs the workstation 30 how to display the person report and the project report respectively. The person report definitions 1020 and the project report definitions 1030 further include a retrieval definition in the form of an SQL statement to retrieve the data from the databases 70 or other data sources 80.

The person report definition 1020 further includes a dossier reference definition 1040 that describes how hyperlinks may be constructed from person dossiers to project dossiers.

As can be seen from FIG. 10, each of the instances of the person report definitions 1020 has a corresponding one of the person template definitions 1050 as is discussed above. The person template definition 1050 include a template form—discussed in connection with FIG. 8—, a search definitions and a dossier linkage relationship 1070 to indicate its relationship with one of a plurality of project template definitions 1060. A person query context subset is defined as all of those reports in the person dossier.

The project template definitions 1060 are similarly related to the project report definitions 1020 and have a template form, a search definitions consisting of a SQL statement and a dossier linkage relationship 1070.

FIG. 11 shows another view of these relationships in which the same reference numerals are used to indicate the same objects as in FIG. 10. In this Figure, the person report definitions 1020 produce three instances of person dossiers 1120, each of which is accessed by one of the URNs 1100. Each of the instances of the person dossiers 1120 refers to one person. The instances of the person dossiers 1120 include reports 1140 with hyperlinks 1110 to one or more project dossiers 1130. The project dossiers are defined by the project dossier definition 1030. As can be seen from this example, the top displayed instance of the person dossier 1120 has two of the hyperlinks 1110 which refer to two different ones of the project dossiers 1130.

The foregoing is considered illustrative of the principles of the invention and since numerous modifications will occur to those skilled in the art, it is not intended to limit the invention to the exact construction and operation described. All suitable modifications and equivalents fall within the scope of the claims.

1. Method for searching at least one data source using a query and comprising the following steps:
a first step of generating a plurality of query templates, where each query template can be used to define at least a part of the query;
a second step of logically joining at least some of said plurality of query templates to create a query representation;
a third step of inputting or selecting input variables into data entry fields of said query representation;
a fourth step for selecting data elements that will be returned by the query;
a fifth step of generating the query using the query representation, input variables and the data elements to be returned;
a sixth step of sending said query to the at least one data source;
a seventh step of returning source results generated using the query from the at least one data source;
an eighth step of generating a reference to a collated data set for each of the source results, and
a ninth step of selecting one of source results.

2. The method according to claim 1, further comprising a prior step of defining how to generate one or more types of collated data set (dossiers).

3. The method according to claim 1, wherein the query template is related to at least part of the definition for generating a dossier.

4. The method according to claim 1, wherein zero source results are returned in the eighth step.

5. The method according to claim 1, wherein the query representation is defined with reference to the dossiers.

6. The method according to claim 1, further comprising a step of searching for matching dossiers by means of the query representation.

7. The method according to claim 6, wherein the step of searching for matching dossiers further includes a step of directly searching the data sources from which the dossiers are derived.

8. The method according to claim 7, wherein the step of searching for matching dossiers includes a step of logically comparing other ones of the dossiers that are indirectly or directly referenced by the dossier being matched.

9. The method of claim 1, further comprising: a tenth step of displaying a selected one of the source results as a displayed dossier.

10. The method of claim 7, further comprising a step of hyperlinking from an element of the displayed dossier to another dossier.

11. The method of claim 1 further comprising a step of defining the content of the dossiers using one or more dossier definitions.

12. The method of claim 11, wherein the dossier definition includes one or more instances of a report definitions, whereby each report definition includes a retrieval definition to define how the members may be retrieved from a data source, a display definition defining how the results may be displayed, and an access definition for defining the permitted access to an instance of the report definition.

13. The method of claim 12, wherein the dossier definition further includes one or more dossier reference definitions, a dossier reference definition defining a link between at least one instance of the report definition and at least one instance of a dossier definition.

14. The method of claim 12, wherein the dossier reference definition defines how a hyperlink is created between an element of a report and a dossier.

15. The method according to claim 12, further including a step of the creation of one or more report template mappings using one of the report definitions.

16. The method according to claim 12 further comprising a step of taking the retrieval definition and inverting said retrieval definition to create a search definition, the search definition being used in the construction of a query that will retrieve source results.

17. The method according to claim 12 further comprising a step of taking the display definition and inverting said display definition to create a template form.

18. The method according to claim 17, wherein one or more columns in a tabular one of the report definitions are associated with one or more of the data entry fields in the associated one of the template forms.

19. The method according to claim 11, further comprising a step of creating a dossier linkage relationship between an element in a template form with a corresponding one of the dossier definitions.

20. The method according to claim 19, wherein the said dossier linkage relationship is created using the dossier reference definition in a corresponding one of the report definitions.

21. The method according to 11, wherein the step of collating the selected source result further includes a step of selecting one of the one or more dossier definition for use in collating the source data.

22. The method according to claim 1, wherein the step of creating a query representation comprises a step of assembling a query structure in which said plurality of query templates are joined using nesting and/or Boolean logic.

23. The method according to claim 22, further including a step of constructing a query representation layer using a plurality of query templates logically joined together using Boolean logic.

24. The method according to claim 1, wherein the step of creating a query representation further comprises a step of creating a plurality of nested query representation layers, wherein the nested query representation layers may be used to check the content of dossiers directly or indirectly referenced by the matching dossier.

25. The method according to claim 11, further comprising a step of creating a plurality of query context subsets of the plurality of query templates wherein each query context subset contains query templates that are associated with a single one of the one or more dossier definition through report template mapping.

26. The method according to claim 1, further comprising a step of creating a plurality of access control subsets of the plurality of query templates, wherein each access control subset contains only those query templates that may be accessed by a particular user of the system.

27. The method according to claim 23 wherein the plurality of query templates belong to a selected one of the plurality of query context subsets and also belong to the access control subset.

28. The method according to claim 1, further comprising a step of defining an initial query context of the query by selecting an initial one of the plurality of dossier definitions.

29. The method according to claim 24 of creating an initial query representation layer.

30. The method according to claim 29, further comprising a step for setting the query context of the initial query representation layer according to the initial query context.

31. The method according to claim 23, further comprising a step of nesting one or more empty query representation layers below a selected one of a plurality of query templates in the query representation layer and of setting a query context of said empty query representation layers.

32. The method according to claim 11, further comprising a step of creating a dossier linkage subset having one or more dossier definitions, wherein each member of the dossier linkage subset has a dossier linkage relationship with the said selected one of the plurality of query templates.

33. The method according to claim 32, further comprising a step of setting a context of the query representation layer by selecting a member of said dossier linkage subset.

34. (canceled)

35. The method according to claim 1, further comprising a step of blocking retrieval of query representations which contain query templates not belonging to the access control subset for a user.

36. The method according to claim 24, further comprising a step of nesting a retrieved query representation below a selected one of the plurality of query templates in the current query representation.

37. The method according to claim 36, further comprising a step of ensuring that an initial context of the said retrieved query representation has a dossier linkage relationship with the said selected one of the plurality of query templates under which it will be nested.

38. The method according to claim 24, further comprising a step of adding a query template with a nested empty query representation layer to the existing query representation.

39. The method according to claim 38, further comprising a step of selecting one of the query representations into which the said query template and nested query representation layer will be added.

40. The method according to claim 38, further comprising a step of creating a template linkage subset of a plurality of linked query templates that have a linkage relationship to the query context of the query representation layer.

41. The method according to claim 40, further comprising a step of selecting one of the plurality of query templates within the template linkage subset.

42. The method according to claim 38, further comprising a step of setting the query context of the said added nested empty query representation layer to be a selected one of the dossier definitions.

43. The method according to claim 40, further comprising a step of creating a dossier definition subset of the dossier definitions wherein the dossier definitions contain report definitions which have a report template mapping to the linked query templates.

44. (canceled)

45. (canceled)

46. The method according to claim 1, further comprising a step of assembling one or more compound query templates from the plurality of query templates and using the compound query templates to create a compound query representation.

47. (canceled)

48. (canceled)

49. (canceled)

50. (canceled)

51. A system for searching data, comprising:
a display device for displaying and editing a set of query templates with data entry fields;
an input device for inputting at least one variable into at least one of the set of query templates;
a query generation device to generate a query using the method of one of claims 1 to 50; and
a display device for viewing the query that will be sent to at least one or more databases source.

52. (canceled)

53. The system according to claim 51 further comprising a query database having a plurality of reports for display on the display device and a plurality of query templates, wherein each one of the plurality of query templates is linked to one of the plurality of reports.

54. The system according to claim 51, further comprising a template generator for generating the query template from a report definition.

55. The system according to claim 51, further comprising a display generator for taking the display description and creating a template display description for the corresponding template, whereby entries in the report definition become data entry fields in the query template.

56. The system according to claim 51, further comprising a search definition engine for taking the retrieval definition and generating a search definition describing how a subset of the dossiers may be created where the corresponding report for each said particular dossier matches a definition created by the input variables in the query template.

57. The system according to claim 56, wherein the search generator engine uses the retrieval definition to automatically generate an SQL search definition.

58. The system according to claim 56, wherein the search definition engine generator combines multiple search definitions according to the query representation to construct a single SQL statement that queries at least one of the data sources.

59. The system according to claim 51, wherein the query generation device converts a query representation into a multiple stage query and wherein results returned from early stages are incorporated into the generation of later stage queries.

60. (canceled)

61. (canceled)

62. (canceled)

63. Database structure for use in a method for searching data sources having a plurality of dossier definitions, report definitions and a plurality of query templates having a plurality of input fields, wherein one of the plurality of report definitions is associated with one of the plurality of query templates.

64. The database structure of claim 61, further comprising a set of access controls on each dossier definition and report definition.

65. The database structure of claim 61, further comprising a display definition defining how to display results returned from the method for searching databases.

66. (canceled)
